(19) United States
(12) Patent Application Publication
(10) Pub. No.: US 2026/0221813 A1
(43) Pub. Date: Jul. 30, 2026

(54) METHOD FOR PRODUCING A STATOR FOR AN ELECTRIC MOTOR

(71) Applicant: Maxon International AG, Sachseln (CH)

(72) Inventors: Thibaut MARQUEYROL, Tafers (CH); Marco WANDELER, Buttisholz (CH)

(21) Appl. No.: 19/141,419

(22) PCT Filed: Dec. 21, 2023
(86) PCT No.: PCT/EP2023/087369

§ 371 Date: Jun. 20, 2025

(30) Foreign Application Priority Data
Dec. 21, 2022 (EP) 22215248.0

(51) Int. Cl. H02K 1/14; H02K 15/022

(52) U.S. Cl. CPC H02K 1/146; H02K 15/022

(57) ABSTRACT

The method includes using a yoke ring and a pole star ring with a plurality of stator teeth for the arrangement of windings, preferably winding packages. The pole star ring can be received in the yoke ring by inserting the pole star ring into the yoke ring. The stator teeth face the yoke ring. The pole star ring can be expanded, thereby causing the stator teeth to press against the yoke ring.

### CROSS-REFERENCE TO RELATED APPLICATIONS

This application claims priority to and the benefit of PCT Patent App. No. PCT/EP 2023/087369, filed on Dec. 21, 2023, and entitled “METHOD FOR PRODUCING A STATOR FOR AN ELECTRIC MOTOR,” and European Patent App. No. 22215248.0, filed on Dec. 21, 2022, and entitled “METHOD FOR PRODUCING A STATOR FOR AN ELECTRIC MOTOR,” the entire contents of which are both herein incorporated by reference.

### BACKGROUND

### 1. Field

The present disclosure relates to a method for producing a stator for an electric motor, with a yoke ring and a pole star ring with a plurality of stator teeth for arranging windings, preferably winding packages, wherein the pole star ring is inserted into the yoke ring. Furthermore, the present disclosure relates to such a stator for an electric motor with a yoke ring and a pole star ring which can be received in the yoke ring and has a plurality of stator teeth for arranging windings, and with an opening for arranging a rotor.

### 2. Related Art

A conventional electric motor has a stator, which forms a stationary motor component, and a rotor, which forms a rotating motor component. With an internal rotor, the stator is usually provided with a stator yoke on which stator teeth project radially inwards. The stator teeth have pole shoes at the ends facing the rotor and are provided with windings that generate an electromagnetic field during operation. To form and amplify the electromagnetic field, the stator yoke with the stator teeth is usually made of a soft magnetic material-for example, in the form of laminated cores.

When manufacturing the stator yoke, it is impossible to apply the windings from the outside through the closed yoke ring, while, from the inside, the pole shoes make access to the stator teeth difficult. With a one-piece stator yoke, a complex winding process is therefore necessary to provide the stator teeth with the necessary windings. For the production of stators of an electric motor, it is therefore known to use a multi-part structure of the stator, wherein there are very different embodiments, e.g., stators composed of C-shaped segments, yoke rings for stators with the individual stator teeth to be attached to them, or two-part stators with a pole star ring and a cylindrical yoke ring. With these multi-part stator concepts, a winding can easily be applied directly to the stator teeth.

Both the pole star ring and the cylindrical yoke ring of a two-part stator are usually made from multiple, individual sheet metal elements that are arranged one above the other in the axial direction and are joined together to form a lamination stack by punching, gluing, welding, baked enamel coating, or other stacking processes. For example, in US 2002/0083572A1, loosely packed stator laminations are aligned using a spreading mandrel and then secured in a motor housing by screwing. Windings are wound onto the freely accessible stator teeth of the pole star ring or pushed onto them as winding packages. After the windings have been fitted to the pole teeth, which are accessible from the outside, the pole star ring is joined by pressing or shrinking. For the press connection between the pole star ring and the yoke ring, manufacturing tolerances can lead to air gaps between the stator teeth and the yoke ring, resulting in magnetic losses in the stator, as well as deformation of the stator teeth and, consequently, to rejection of the stator.

In the two-part stators known in the prior art, with a pole star ring and a yoke ring, the pole star ring is pressed axially into the yoke ring when the components are joined together. The mechanical contact of the components during axial pressing can cause notches on the components as well as chips that negatively affect the operation of the electric motor. Furthermore, splitting can occur in the laminated cores of the pole star ring and the yoke ring, which means that the laminates no longer lie flat against each other, which leads to magnetic losses in the stator. In addition, precise contours and tight tolerances of the pole star ring and the yoke ring are required during axial pressing, to avoid air gaps between the stator teeth and the yoke ring or to ensure a consistent outer diameter of the yoke ring.

From DE 10 2015 000 769 A1, for example, a stator for an electric motor with a non-positive or friction press connection between the stator teeth of a pole star ring and a yoke ring is known, wherein the yoke ring is pressed axially onto the pole star ring, and, in addition, a material bond is created via a microencapsulated adhesive. In DE 10 2016 201 967 A1, a tangential press connection between the stator teeth of a pole star ring and a yoke ring is described for production of a stator in a reliable process, wherein the stator teeth are designed with a slot-shaped, resilient recess and are inserted into axial grooves of the yoke ring in order to achieve a press fit to the yoke ring via tangential forces.

### SUMMARY

It is therefore the object of the present present disclosure to provide an improved method for producing a stator for an electric motor, which simplifies the production and mounting of the pole star ring and yoke ring, while at the same time reducing waste and ensuring functionally reliable quality of the stator.

The object underlying the present disclosure is achieved in a method for producing a stator for an electric motor by providing a yoke ring and a pole star ring with a plurality of stator teeth for arranging windings, preferably winding packages, wherein the pole star ring can be received in the yoke ring, by inserting the pole star ring into the yoke ring, wherein the stator teeth face the yoke ring, and by spreading the pole star ring, wherein the stator teeth are pressed against the yoke ring. This method enables a secure and chip-free arrangement of the pole star ring in the yoke ring. It makes sense to arrange windings on the stator teeth before inserting the pole star ring, wherein individual prefabricated winding packages can be pushed onto the stator teeth from the outside. To form the pole star ring, the individual stator teeth are connected to one another in the region of the inner pole shoes—for example, with plastically deformable elements, preferably with stretchable connecting pieces. When inserting the pole star ring into the yoke ring, the stator teeth are arranged in the yoke ring with little or no mechanical stress, so that neither notches nor chips nor splitting can occur in the laminated cores of the stator teeth or the yoke ring. The ends, facing away from the pole shoes, of the stator teeth then face the inner circumferential surface of the yoke ring in the radial direction. It is advisable to place the yoke ring in a thick-walled support ring before spreading the pole star ring arranged therein, so that the yoke ring is not widened or deformed by the radial pressing force during spreading. Due to the force acting in the radial direction upon the stator teeth, the free ends of the stator teeth are pressed against the yoke ring, resulting in a press fit between the pole star ring and the yoke ring. The deformable elements between the stator teeth are stretched, extended, or bent when the pole star ring is spread.

A favorable embodiment provides that the pole star ring have an opening with an inner diameter for arranging a rotor, and spreading the pole star ring widen the inner diameter of the opening. This centrally located opening of the pole star ring enables a safe and easy application of radial force to spread the pole star ring, wherein the final inner diameter for arranging the rotor in the fully mounted stator is attained only after the pole star ring has been spread. For an error-free and efficient electric motor, a uniform distance between the stator teeth or pole shoes and the rotor is necessary, which is why all stator teeth are pressed as evenly as possible onto the yoke ring.

In an advantageous variant of the method, one or more inwardly projecting connecting pieces are provided in the spaces between the individual stator teeth to form the pole star ring, wherein, by pressing on the connecting pieces, the connecting pieces are straightened, and the pole star ring is thereby spread. By applying a force to the connecting pieces, they can be deformed and/or straightened. This widens the inner diameter of the pole star ring opening, which presses the stator teeth against the yoke ring. The deformation can be carried out plastically without heating, which reduces the complexity of the production process. In addition, the permeability of the connecting pieces is reduced, thereby reducing unwanted magnetic flux across the connecting pieces.

An advantageous embodiment provides that the yoke ring on an inner circumferential surface have a plurality of recesses for receiving the stator teeth of the pole star ring, and that the stator teeth be pressed into the recesses when the pole star ring is spread. This enables a permanent fixation of the ends of the stator teeth to the inner circumferential surface of the yoke ring by means of a tangential holding force. The recesses on the inner circumferential surface can be designed as axial grooves, wherein radially deeper grooves and small remaining gaps between the yoke ring and the stator teeth enable a lower dispersion of the cogging torque between the individual teeth and the yoke ring. The provision of recesses and the pressing of the stator teeth into the recesses further allows the precise positioning of the stator teeth in the stator and thus an increase in the efficiency of the electric motor.

A modification of the method provides that a spreading tool, preferably a spreading tool with a wedge-shaped spreading element, be inserted into the pole star ring in order to spread the pole star ring. Preferably, the spreading tool is inserted into the pole star ring after the pole star ring has been inserted into the yoke ring. The use of a suitable spreading tool enables the pole star ring to be spread evenly and thus also ensures a good and even connection of the plurality of stator teeth to the yoke ring. A practical design provides that the spreading tool be inserted in the axial direction into the rotor opening of the pole star ring and stretch there evenly in the radial direction in order to spread the pole star ring evenly by applying a radial force. The wedge-shaped spreading element can comprise a conical cone which is inserted into a spreadable conical cylinder. The deeper the conical cone is inserted into the conical cylinder, the more the outer circumference of the conical cylinder increases, wherein the cylindrical outer surface of the conical cylinder presses on the pole star ring or on the connecting pieces of the pole star ring. Due to the cylindrical outer shape, the contact force is evenly distributed over the entire axial length of the stator. The contact pressure is applied at right angles to the axis of rotation of the motor or the rotor.

In a special variant, the spreading tool has multiple, radially movable struts, preferably, for each stator tooth, one strut assigned to the stator tooth, wherein the struts are pressed radially outwards in order to spread the pole star ring. The radial force of the spreading tool is exerted directly on the individual stator tooth via the strut that presses centrally on the stator tooth. If a simultaneous and uniform radial force is applied to all stator teeth of the pole star ring, this results in a uniform contact pressure of all stator teeth against the yoke ring.

An alternative method variant provides that one or more inwardly projecting connecting pieces be provided in the spaces between the individual stator teeth to form the pole star ring, and the spreading tool have multiple, radially movable struts, preferably one strut assigned to each space between the individual stator teeth, wherein the struts are pressed radially outwards in order to straighten the connecting pieces and thereby spread the pole star ring. In the spaces between the individual stator teeth, one or more connecting pieces, preferably bent connecting pieces, can be provided, wherein the radially movable struts of the spreading tool substantially bear against all connecting pieces of a space and press them outwards. For spreading the pole star ring, the struts of the spreading tool are positioned substantially centrally between the stator teeth in order to press as evenly as possible on the respective connecting pieces. By bending the connecting pieces and/or straightening the previously bent connecting pieces, the magnetic conductivity of the material of the connecting pieces is reduced, since this material saturates more quickly after the bending process. The reduction in the magnetic conductivity at the connecting pieces of the individual stator teeth of the pole star ring is advantageous during operation of the electric motor, since the webs between the individual stator teeth form an undesirable magnetic short circuit.

In an advantageous variant of the method, the connecting pieces are removed after the pole star ring has been spread, in particular by cutting or vaporizing with a laser beam under water. This prevents the magnetic short circuit between the stator teeth, enabling higher torque. Due to their proximity to the winding package, the removal of the connecting pieces is possible only to a limited extent by punching or mechanical cutting.

A useful design provides that the spreading tool have an axially movable working wedge and the struts of the spreading tool have wedge-shaped pressing surfaces. The conically widening working wedge, which can be moved in the axial direction to the rotor opening, enables a uniform radial force to be applied to the stator teeth or the connecting pieces of the pole star ring via the wedge-shaped pressing surfaces of the struts, so that the stator teeth are pressed evenly outwards and against the yoke ring by the axially movable working wedge.

Furthermore, the present present disclosure relates to a stator for an electric motor, having a yoke ring, preferably a cylindrical yoke ring, a pole star ring which can be received in the yoke ring and has a plurality of stator teeth and a rotor opening, and also windings, preferably winding packages, which are arranged on the stator teeth. According to the present disclosure, the stator teeth of the pole star ring are connected to one another via stretchable connecting pieces, wherein the connecting pieces are plastically deformed in the mounted state compared to the original state of the stator, and the stator teeth are pressed against the yoke ring compared to the original state. In its original or pre-mounted state, the stator is unmounted in individual parts that are not attached to one another. This enables precise alignment and secure arrangement of the stator teeth on the yoke ring, wherein the stator teeth and/or the pole shoes have the same radius and/or the same distance from the rotor axis inwards, so that the as uniform air gap as possible to the rotor can be guaranteed later in the electric motor. This not only improves the efficiency of the electric motor by the precise positioning of the stator teeth in the yoke ring, but also reduces production waste and the susceptibility to defects in the electric motor by avoiding chips, deformations, and splitting of the laminated cores during stator production. The stretchable connecting pieces, in particular plastically deformable connecting pieces, whose deformation is not, or is not completely, reversible after a radial force is applied, between the individual stator teeth of a pole star ring enable a quick and easy positioning of the pole star ring in the yoke ring before a radial force is applied, and a uniform spreading of the pole star ring and pressing of the stator teeth against the yoke ring by the radial force application. This enables a safe, fast, and therefore cost-effective production of a stator with a permanent press fit of the stator teeth against the inner circumferential surface of the yoke ring. The connecting pieces also enable a magnetic short circuit between the stator teeth, which can reduce existing torque ripple, depending upon the wiring, pole pairs, and number of teeth of the electric motor.

For good magnetic conductivity of the stator, the pole star ring can be designed as a stack of stator laminations, wherein individual stator laminations are designed as lamination rings that extend over all stator teeth of the pole star ring and form stretchable connecting pieces between the stator teeth. This enables not only good magnetic conductivity of the stator teeth, but also a simple formation of the stretchable connecting pieces. The stator laminations can be designed as blanks or punched-out lamination rings and can be joined to form a lamination stack by punching, gluing, welding, bonding, or the like. At least three stator laminations of the pole star ring can be designed as lamination rings, wherein the lamination rings are preferably evenly distributed over the thickness of the lamination stack. For example, every fifth, tenth, or twentieth stator lamination of the lamination stack can be designed as a lamination ring in order to enable a correspondingly functionally reliable design of the pole star ring. In an alternative form, all stator laminations of the lamination stack can also be designed with a thin connecting piece, which, after spreading the pole star ring and pressing the stator teeth onto the yoke ring, creates a closure of the stator in the direction of the rotor opening and allows all winding cavities between the closed pole star ring and the yoke ring to be cast, without the need for additional sealing to the inside.

Advantageously, the stretchable connecting pieces can be designed as bent connecting pieces, preferably with a bend in the radial direction. This allows the simple provision of both sufficient stretchability to spread the pole star ring, as well as plastic deformability to ensure sufficient stability of the pole star ring when it is inserted into the yoke ring—and, after the spreading, pressing the stator teeth onto the yoke ring. Typically, the bent connecting pieces between the stator teeth are positioned at the inner ends of the stator teeth and/or the pole shoes, and have an outwardly curved bend.

In an alternative form, the stretchable connecting pieces can also be designed as connecting pieces bent in the radial direction and curved towards the opening, wherein these inwardly curved connecting pieces protrude in particular into the central opening of the pole star ring in a pre-mounted state. Curved inwards means curved towards the center of the stator or the pole star ring. The center of the stator lies on the axis of rotation of the motor or rotor. These inwardly curved connecting pieces are stretched or straightened directly by the struts of the spreading tool during the spreading, which significantly reduces the magnetic conductivity of the connecting pieces. The connecting pieces have a certain degree of rigidity. When pressed against the stator teeth, the connecting pieces are stretched. As soon as the pressure on the stator teeth decreases, the connecting pieces partially spring back to their original shape. When the struts of the spreading tool are pressed onto the connecting pieces, the contact pressure directly deforms the connecting pieces. This reduces the springback of the material or the connecting pieces after the spreading tool has been removed. This defines the radius of the stator interior, in which the motor rotor rotates, more precisely. Pressing on the connecting pieces bends them to a predefined position, and thus to a defined inner diameter of the opening. The inner diameter of the opening corresponds to the stator inner radius. Due to smaller tolerances in the inner diameter, a larger rotor can be inserted into the stator, which allows a smaller air gap between the stator and rotor, and thus a greater torque, to be achieved.

Preferably, the connecting pieces have a break notch. In particular, the break notch may have been punched out. Due to the tensile or bending stress during spreading, the connecting pieces can break during the spreading movement. The radial spreading movement of the spreading tool can be increased for this purpose. The breakage of the connecting pieces prevents the magnetic connection or a magnetic short circuit between the stator teeth and increases the possible torque.

A useful embodiment provides that the yoke ring have a plurality of recesses, distributed on the inner circumferential surface, for receiving the radial ends of the stator teeth. The provision of substantially uniformly distributed recesses allows for a uniform arrangement and more precise positioning of the stator teeth during stator manufacture. In particular, these recesses, distributed on the inner circumferential surface of the yoke ring, can be designed as grooves running in the axial direction. The yoke ring is preferably cylindrical in shape. The lateral edges of the grooves allow for more precise positioning of the stator teeth, while at the same time allowing a tangential press fit between the edges of the grooves and the radial ends of the stator teeth, the effect of which improves with the depth of the grooves. The radial ends of the stator teeth can also be rectangular in shape in order to be securely held in the grooves by the tangential press fit and thus securely connected to the yoke ring. The press fit at the edges of the grooves running in the axial direction enables not only a tangential force introduction onto the stator teeth, but also an exact alignment of the stator teeth in the direction of the rotor axis. In this design, the stretchable connecting pieces are used only to position the stator teeth relative to the yoke ring when inserting and spreading the pole star ring. Once the stator teeth are securely pressed into the grooves on the inner circumferential surface of the yoke ring, the stretchable connecting pieces between the individual stator teeth can be removed after the pole star ring has been spread, since the stator teeth are securely positioned in the grooves and connected to the yoke ring by the tangential press fit. In this advantageous design, the magnetic short circuit between the stator teeth is eliminated, which enables a higher torque. The removal of the connecting pieces can preferably be carried out by cutting or vaporizing with a laser beam under water. Due to their proximity to the winding package, the removal of the connecting pieces is possible only to a limited extent by punching or mechanical cutting.

### BRIEF DESCRIPTION OF THE DRAWINGS

Below, non-limiting embodiments of the present present disclosure are explained in more detail with reference to drawings shown by way of example, in which:

FIG. 1 is a perspectival view of a pole star ring for a stator according to the present disclosure,

FIG. 2 is a perspectival view of the pole star ring of FIG. 1 and multiple, individual winding packages,

FIG. 3 is a perspectival view of the pole star ring of FIGS. 1 and 2 with the winding packages pushed on,

FIG. 4 is a perspectival view of the pole star ring with plugged-on winding packages of FIG. 3 and a yoke ring,

FIG. 5 is a perspectival view of the yoke ring of FIG. 4 with the pole star ring inserted,

FIG. 6A is a perspectival view of a stator according to the present disclosure with the yoke ring from FIGS. 4 and 5 and the spread and pressed-in pole star ring of FIG. 3,

FIG. 6B is an enlarged, partial sectional view of the stator of FIG. 6 with a schematically illustrated spreading tool,

FIG. 7A is a sectional view of the stator of FIG. 6A without winding packages and with a schematically illustrated spreading tool,

FIG. 7B is a sectional view of the stator of FIG. 7A without winding packages and without spreading tool,

FIG. 8A is a perspectival sectional view through the stator of FIG. 6A with a spreading tool accommodated therein,

FIG. 8B is a sectional view through the stator and the spreading tool of FIG. 8A, and

FIG. 9 is an enlarged, partial sectional view of a further embodiment of a stator according to the present disclosure with a schematically illustrated spreading tool.

### DETAILED DESCRIPTION OF THE ENABLING EMBODIMENTS

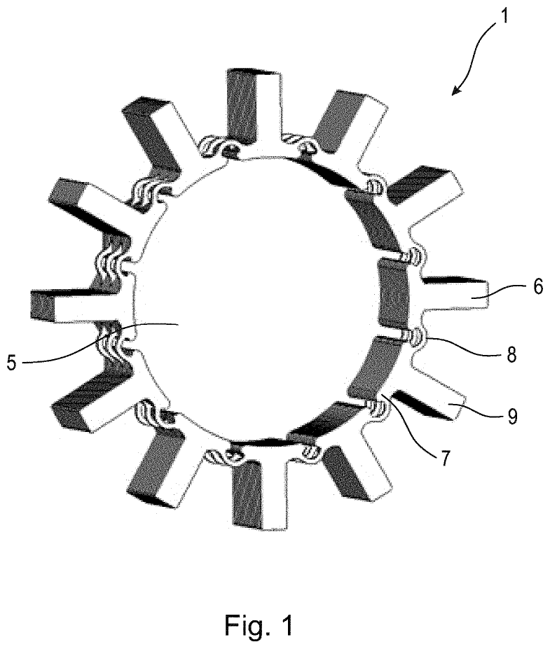

FIG. 1 shows a perspectival view of a pole star ring 1 which, together with a yoke ring 2 and winding packages 3, forms a stator 4 according to the present disclosure. In the embodiment shown, the star-shaped pole star ring 1 is manufactured as a laminated core of multiple layers of stator laminations which are layered one above the other in the axial direction and connected to one another, e.g., by being stamped together, to form a central, cylindrical opening 5. When the stator 4 is mounted, the rotor of the electric motor is accommodated in the opening 5, and can rotate in the axial direction. The star-shaped pole star ring 1 comprises a plurality of radially outward-extending stator teeth 6, which form pole shoes 7 on the inner side located radially to the cylindrical opening 5, which, in the mounted state, face the rotor of the electric motor. In order to position the stator teeth 6 in the pole star ring 1 and to form the closed ring of the pole star ring 1 around the opening 5, the stator teeth 6 are connected to one another in the region of the pole shoes 7 via stretchable connecting pieces 8. In the embodiment of the pole star ring 1 shown in FIG. 1, the connecting pieces 8 are designed as radially outward-bent webs which are formed by individual stator laminations of the pole star ring 1 designed as a laminated core. In the embodiment shown, only individual laminations are provided with connecting pieces 8; for example, only every fifth, tenth, or twentieth lamination has connecting pieces 8. The connecting pieces 8 are usually evenly distributed over the thickness of the stator teeth 8 in the axial direction.

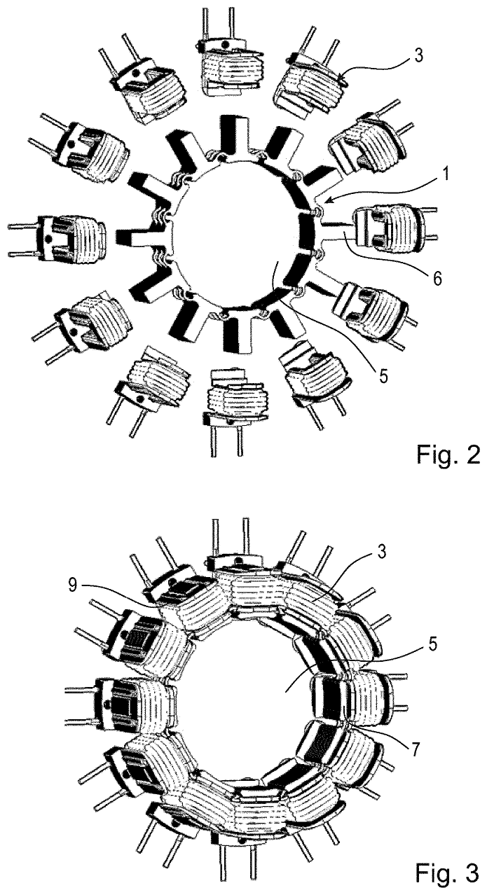

As shown in FIGS. 2 and 3, individual prefabricated winding packages 3 are pushed onto the stator teeth 6 projecting outwards in the radial direction, wherein each stator tooth 6 is provided with a winding package 3; see FIG. 2. As can be seen in the perspectival view of the pole star ring 1 in FIG. 3, the winding packages 3 are pushed completely onto the stator teeth 6 up to the pole shoe 7, so that the radially outward-projecting ends 9 of the stator teeth 6 protrude slightly from the winding packages 3.

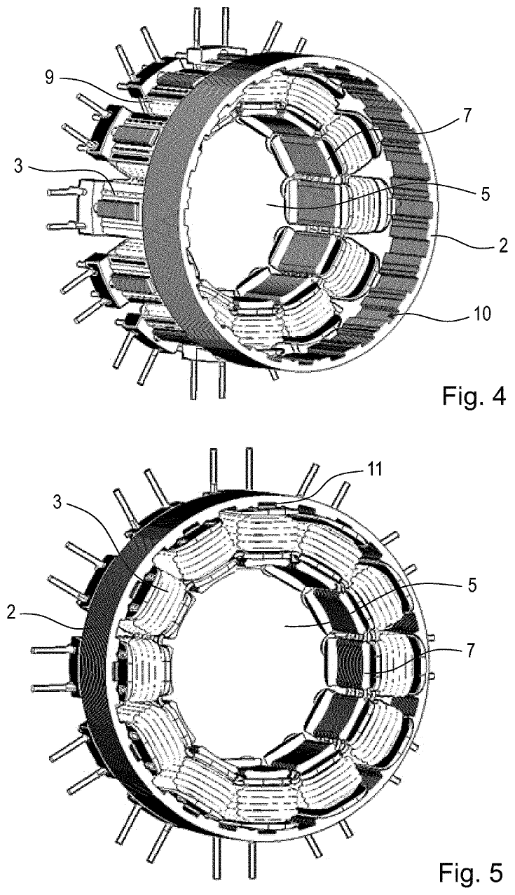

The perspectival view in FIG. 4 shows the pole star ring 1 with the winding packages 3 pushed onto the stator teeth 6, as well as the yoke ring 2 in a mounted position. The yoke ring 2 has recesses 10 on the inner circumference for positioning the stator teeth 6, which in this embodiment are designed as grooves 19 running in the axial direction. In the mounted position shown here, each radially projecting end 9 of the stator teeth 6 is aligned with a groove 19, extending in the axial direction, on the inner circumference of the yoke ring 2. Like the pole star ring 1, the yoke ring 2 can also be manufactured as a laminated core made of stator laminations stacked in layers. As can be seen in FIG. 5, the yoke ring 2 is pushed onto the pole star ring 1 in the axial direction during mounting, wherein the protruding ends 6 of the stator teeth 6 are merely guided through the grooves 19 on the inner circumference of the yoke ring 2, so that no chips or notches can occur on the grooves 19 and the protruding ends 9. A gap 11 remains between the protruding ends 9 and the groove base 20 of the grooves 19.

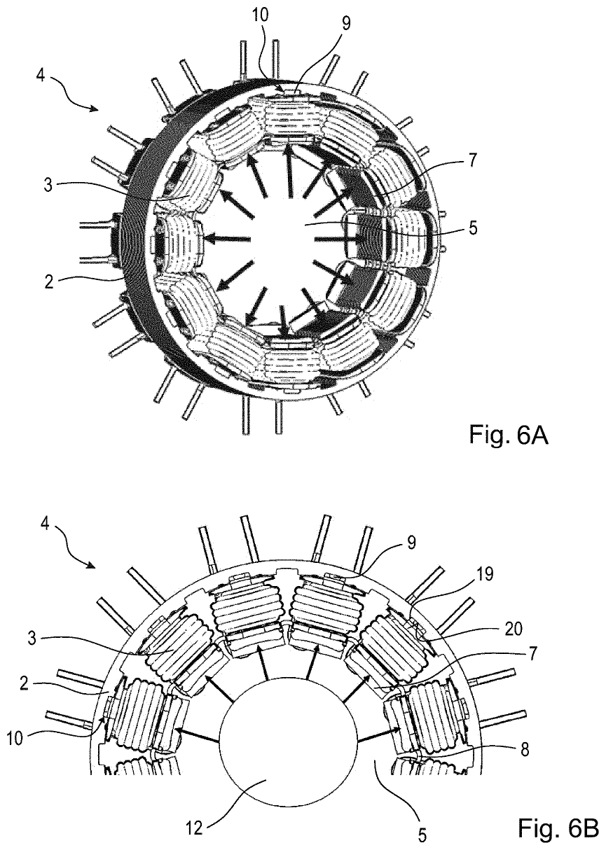

After positioning the pole star ring 1 in the yoke ring 2, a force acting in the radial direction is exerted from the opening 5 onto each stator tooth 6 and/or each pole shoe 7 of the stator teeth 6, so that the projecting ends 9 of the stator teeth 6 are pressed into the recesses 10. As can be seen in FIG. 6A, the projecting ends 9 of the stator teeth 6 then rest on the base 20 of the grooves 19, so that the initially existing gap 11 is substantially filled by the projecting ends 9.

When the pole star ring 1 is radially spread and the projecting ends 9 are pressed into the recesses 10 of the yoke ring 2, the opening 5 widens, and the distance between the individual stator teeth 6 increases. Due to the increasing distance between the stator teeth 6, the stretchable connecting pieces 8 between the stator teeth 6 are stretched when the pole star ring 1 is radially spread, so that the bending of the connecting pieces 8 flattens. Since the connecting pieces 8 in this embodiment are formed by the stator laminations of the laminated core of the pole star ring 1, the greatest part of the stretching of the connecting pieces 8 takes place as plastic deformation. This can also be seen in the enlarged, partial sectional view with the spread pole star ring 1 and the stator teeth 6 pressed into the grooves 19 of the yoke ring 2 in FIG. 6B. By means of the spreading tool 12, which is only shown schematically here, a radial force is applied to the stator teeth 6, so that the protruding ends 9 of the stator teeth 6 are pressed firmly into the grooves 19 of the yoke ring 2, wherein the bending of the connecting pieces 8 flattens in order to compensate for the larger distance between the stator teeth 6.

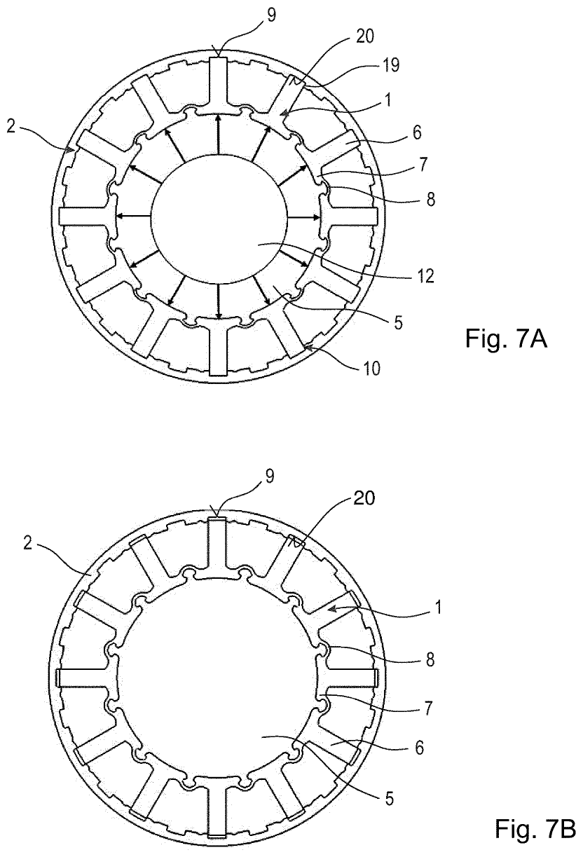

The press fit between the stator teeth 6 and the yoke ring 2 is substantially generated by tangential forces between the side walls of the grooves 19 and the protruding end 9 of the stator teeth 6. Due to the permanent press-fit connection between the stator teeth 6 and the yoke ring 2, after the pole star ring 1 has been spread, the connection between the individual stator teeth 6 via the connecting pieces 8 is no longer necessary, which is why the connecting pieces 8 could also be removed after the spreading process. Furthermore, due to the uniform spreading process and the uniform pressing of the stator teeth 6 into the yoke ring 2, all stator teeth 6 are pressed outwards substantially evenly and to the same extent by the spreading tool 12, so that the pole shoes 7 of the stator teeth 6 are all at the same distance from the axial axis. This can be seen particularly well in the sectional views of the stator 4 without winding packages 3 in FIGS. 7A and 7B.

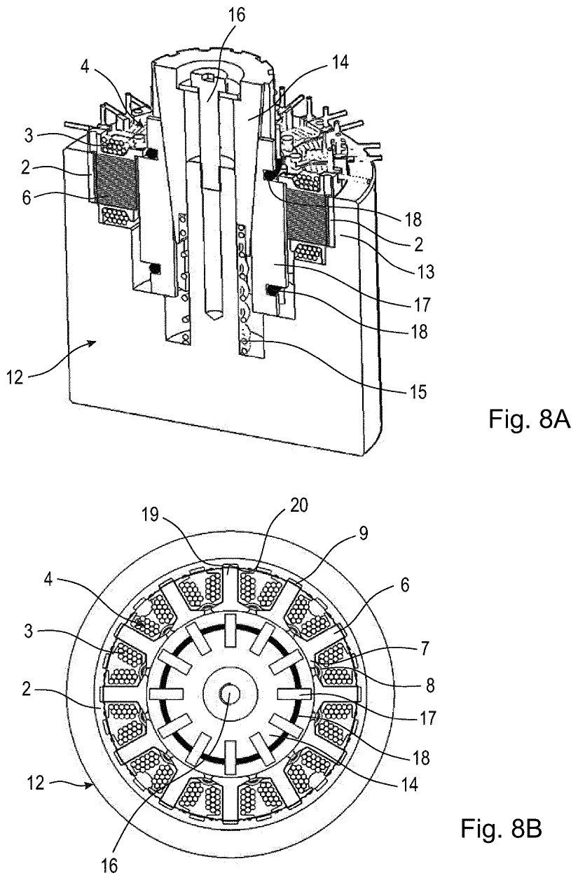

FIG. 8A shows a perspectival sectional view through a spreading tool 12 with a stator 4 arranged therein. The spreading tool 12 has a thick-walled support ring 13 against which the yoke ring 2 rests during the spreading and pressing process, so that the yoke ring 2 is not widened or bent. In this sectional view, the structure of the stator teeth 6 and/or the pole star ring 1 made of a laminated core of stator laminations stacked in layers can also be seen. The spreading tool 12 has a working wedge 14 which is movable in the axial direction, wherein the working wedge 14 is moved in the axial direction against the preload force of a spring 15 by means of a centrally arranged threaded bolt 16. The conically tapered flanks of the working wedge 14 act upon multiple, radially movable struts 17, which are held on the working wedge 14 via elastic rings 18; see also FIG. 8B. The force applied in the axial direction via the working wedge 14 is transferred via the inclined inner flanks of the struts 17 into a radial force which, on the straight outer flanks of the struts 17, acts uniformly upon the stator teeth 6 and presses them into the recesses 10 on the yoke ring 2.

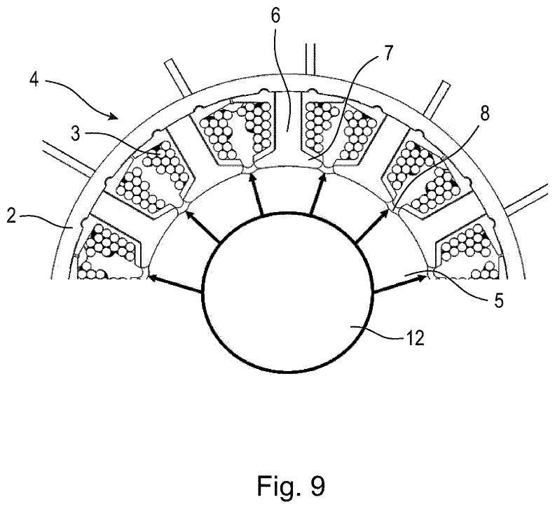

A further embodiment of a stator 4 according to the present disclosure and a corresponding method for production are shown in FIG. 9, in which an enlarged, partial sectional view of the stator 4 and a schematically illustrated spreading tool 12 are shown. The pole star ring 1 of this stator 4 according to the present disclosure again has a plurality of stator teeth 6 with internal pole shoes 7 and projecting ends 9. The pole star ring 1 is arranged in a yoke ring 2, and each stator tooth 6 of the pole star ring 1 is provided with a winding package 3 previously pushed on from the outside. The individual stator teeth 6 are provided with plastically deformable connecting pieces 8 at the edges of the pole shoes 7 to form the pole star ring 1, wherein the bend of the connecting pieces 8 projects inwards into the opening 5 of the pole star ring 1 relative to the pole shoes 7. In this variant, the spreading tool 12 generates a radial force which acts upon the connecting pieces 8 between the individual stator teeth 6 and straightens the connecting pieces 8 to spread the pole star ring 1. As a result, the projecting ends 9 of the stator teeth 6 are pressed against the inner circumferential surface of the yoke ring 2 in order to create a permanent press fit of the pole star ring 1 or the stator teeth 6 on the yoke ring 2. By bending the connecting pieces 8, the magnetic conductivity of the connecting pieces 8 is reduced, in order to reduce the undesirable magnetic short circuits between the individual stator teeth 6. In this embodiment, too, recesses 10 or grooves 19 extending in the axial direction can be provided on the inner circumferential surface of the cylindrical yoke ring 2 in order to precisely position the stator teeth 6.

What is claimed is:

1. A method for producing a stator for an electric motor, having the steps of:
providing a yoke ring and a pole star ring with a plurality of stator teeth for arranging windings, preferably winding packages, wherein the pole star ring can be received in the yoke ring;
inserting the pole star ring into the yoke ring, with the stator teeth facing the yoke ring; and
spreading the pole star ring, such that the stator teeth are pressed against the yoke ring.

2. The method according to claim 1, wherein the pole star ring has an opening with an inner diameter for arranging a rotor, and wherein spreading the pole star ring widens the inner diameter of the opening.

3. The method according to claim, wherein one or more inwardly projecting connecting pieces are provided in spaces between the individual stator teeth to form the pole star ring, and wherein the pole star ring is spread by pressing on the connecting pieces.

4. The method according to claim 1, wherein the yoke ring on an inner circumferential surface has a plurality of recesses for receiving the stator teeth of the pole star ring, and, wherein when the pole star ring is spread, the stator teeth are pressed into the recesses.

5. The method according to claim 1, wherein a spreading tool is introduced into the pole star ring in order to spread the pole star ring.

6. The method according to claim 5, wherein the spreading tool has a plurality of radially movable struts stator and wherein the struts are pressed radially outwards to spread the pole star ring.

7. The method according to claim 5, wherein one or more inwardly projecting connecting pieces are provided in the spaces between the individual stator teeth to form the pole star ring, and wherein the spreading tool has multiple, radially movable struts, and
wherein the struts are pressed radially outwards in order to straighten the connecting pieces and thereby spread the pole star ring.

8. The method according to claim 7, wherein the connecting pieces are removed after the pole star ring has been spread, in particular by cutting or vaporizing with a laser beam under water.

9. A stator for an electric motor, comprising:
having a yoke ring and a pole star ring which can be accommodated in the yoke ring and which has a plurality of stator teeth, and an opening for arranging a rotor, as well as windings, which are arranged on the stator teeth,
wherein the stator teeth of the pole star ring are connected to one another via stretchable connecting pieces, wherein the connecting pieces are plastically deformed in the mounted state compared to an original state of the stator, and wherein the stator teeth are pressed against the yoke ring compared to an original state.

10. The stator according to claim 9,
wherein the pole star ring is designed as a stack of stator laminations, wherein individual stator laminations are designed as lamination rings which extend over all stator teeth of the pole star ring and form the stretchable connecting pieces between the stator teeth.

11. The stator according to claim 10,
wherein at least three stator laminations are designed as lamination rings, wherein the lamination rings are preferably evenly distributed over the thickness of the lamination stack.

12. The stator for an electric motor according to claim
wherein the stretchable connecting pieces are designed as bent connecting pieces

13. The stator according to claim 12,
wherein the stretchable connecting pieces are designed as connecting pieces which are bent in a radial direction and are curved towards the opening, and wherein the connecting pieces in a pre-mounted state protrude in particular into the opening of the pole star ring .

14. Stator The stator according to any of claim 12, wherein the connecting pieces have a break notch.

15. The stator according to any of claim 9,
wherein the yoke ring has a plurality of recesses, distributed on the inner circumferential surface, for receiving the radial ends of the stator teeth.

16. The stator according to claim 15,
wherein the recesses distributed on the inner circumferential surface of the yoke ring are designed as grooves running in the axial direction.

17. The method according to claim 5, wherein the spreading tool has a wedge shaped spreading element.

18. The method according to claim 6, wherein the spreading tool has one strut that is assigned to each stator tooth.

19. The stator according to claim 9, wherein the yoke ring is a cylindrical yoke ring.

20. The stator according to claim 12, wherein the bent connecting pieces have bends in a radial direction.
